(19) United States
(12) Patent Application Publication
(10) Pub. No.: US 2024/0375423 A1
(43) Pub. Date: Nov. 14, 2024

(54) SECURITY ELEMENT WITH MOTIF-FORMING LIQUID-CRYSTAL LAYER

(71) Applicant: Giesecke+Devrient Currency Technology GmbH, Munchen (DE)

(72) Inventors: Winfried HOFFMULLER, Bad Tolz (DE); Andreas RAUCH, Ohlstadt (DE); Bjorn TEUFEL, Weissach (DE); Josef SCHINABECK, Kreuth (DE); Manfred HEIM, Bad Tolz (DE); Thomas MANG, Holzkirchen (DE)

(21) Appl. No.: 18/658,670

(22) Filed: May 8, 2024

(30) Foreign Application Priority Data
May 8, 2023 (DE) 102023111992.3

(51) Int. Cl. B42D 25/364; B41M 3/14; B42D 25/23; B42D 25/324

(52) U.S. Cl. CPC B42D 25/364; B41M 3/14; B42D 25/23; B42D 25/324

(57) ABSTRACT

A security element for safeguarding of articles of value, has a motif layer based on a liquid-crystalline material intended and destined to form a latent motif. The security element includes a first embossing varnish layer disposed on a carrier film, a partial motif layer based on a nematic liquid-crystalline material, and a single- or multilayer second embossing varnish layer present over the full area. The first embossing varnish layer has been provided with an embossment having at least two regions with alignment structures of different orientation for formation of a second latent motif. The motif layer, in the form of a first latent motif, is disposed in regions directly atop the first embossing varnish layer and in an overlapping arrangement with the regions that form the second latent motif.

### BACKGROUND

The invention relates to a security element for safeguarding of articles of value, having a motif layer based on a liquid-crystalline material designed and destined to form a latent motif. The invention further relates to a corresponding production method and to a data carrier comprising such a security element.

Data carriers, such as documents of value or ID documents, but also other articles of value, for instance brand articles, are often safeguarded by provision with security elements that permit verification of authenticity of the data carriers and simultaneously serve as protection from unauthorized reproduction. A major role in the safeguarding of authenticity is played by security elements with viewing angle-dependent or three-dimensional appearance, since these cannot be reproduced even with the most modern copying devices.

In many cases, the exceptional properties of liquid-crystalline materials are also exploited, and in particular the viewing angle-dependent color impression and/or light-polarizing effect of liquid crystals.

Such materials are virtually invisible after application to a carrier, but show marked visual optical effects in the case of a corresponding background, for example a reflective print substrate and with the aid of linear or circular polarizers. Only when viewed through a linear or circular polarizer do the coated regions stand out to a greater or lesser degree. The impressions here may additionally be dependent to a high degree on the (angular) position of the polarizer.

The basis for the methods used in this context is, for example, that the nematic liquid-crystal layer has been provided atop a reflective metal layer in order to enable good discernability of the polarization effects. Document WO 2005/105475 A1 describes a method in which the nematic liquid-crystalline material, for example a solvent-based UV-crosslinkable liquid-crystal varnish, has been printed onto a carrier film in a pattern.

The polymeric carrier films used in these methods, because of their internal structure, have a preferential direction (in running direction) which is sufficient to align the liquid-crystalline material in the desired form. Especially suitable are polymer films that have a surface structure formed in the course of production, for example PET films.

A UV-curable embossing varnish layer is then applied over the full area in a further step above the carrier film and the nematic layer. A desired embossed structure, for example a diffraction structure, is embossed into the embossing varnish layer, and a reflective layer, for example in the form of a metal layer, is applied, especially by vapor deposition, into which cutouts may be introduced by partial demetallization. Lastly, for the transfer to a target substrate (e.g. paper), an adhesion-promoting layer or primer layer is applied to the layer composite, and an adhesive layer is applied thereto.

This results in the following layer sequence viewed from the top: nematic liquid crystals, UV varnish (with embossed structure), metallization. Without auxiliary means, the layer composite shows only the optically variable diffraction structures provided by the embossed structure, for instance holograms. If this, by contrast, is viewed through a circular polarization filter, additional structures will appear. Regions with metallization and without nematic liquid-crystal layer have a black or at least dark appearance, whereas regions with nematic liquid crystals show a light appearance. Horizontal rotation of the circular polarization filter does not lead to any change in contrast.

Alternatively, the structures can also be made visible with a linear polarization filter (or a circular polarization filter viewed through the reverse side, i.e. one that has been “inverted”). In that case, the regions having metallic coating always have a light appearance without liquid-crystal coating. In the regions that have additionally been provided with the nematic liquid-crystalline material, it is possible by suitable horizontal rotation of the linear polarization filter either to create a dark impression that contrasts with the regions without the nematic layer or for the regions to show a light appearance without perceptible contrast from the surrounding metallized regions.

Liquid-crystalline layers that are produced from a solvent-containing formulation can generally be applied in high resolution only with difficulty since considerable wet film thicknesses would have to be printed, which show considerable running or “flowing” after printing because of the low viscosity of the formulations.

For optimal contrast, the nematic liquid crystal layer forms a λ/4 layer for light from the intended wavelength range. Depending on the birefringence of liquid crystal molecules, a particular layer thickness (of the order of magnitude of 1 g/m²) is required, and therefore it is not possible to print as thinly as desired. Addition of thickeners generally leads to a loss of quality in the optical properties of the liquid-crystal layers.

Optically anisotropic films in the optical pathway can likewise reduce the achievable contrast, as a result of which releasability from the carrier film is advantageous. Very thin UV-crosslinked (liquid-crystal) layers, however, often have poor releasability.

In general, solvent-based liquid-crystal varnishes require alignment-promoting conditions in order to be able to display their effect. In further methods, for this purpose, specific alignment layers are used. In particular, alignment layers consisting of a linear photopolymer are employed, which is exposed to suitable radiation for alignment. In addition, liquid-crystalline materials can also be aligned with the aid of alignment layers that are provided by a finely structured layer or a layer aligned through exertion of shear forces.

If, for example, an aligning embossed structure having two different orientations is coated with nematic liquid-crystalline material, the different alignment of the liquid crystals in different regions that is achieved as a result has the effect that the embossed motif can be rendered visible with a linear polarization filter (by rotation of the polarization filter) in positive or negative contrast. With a circular polarization filter, by contrast, it is not possible to discern any motif.

Security elements with latent images are also used, where the liquid-crystal layer is based on a liquid-crystalline mixture containing dichroitic dyes, as described, for example, in document WO 2019/068655 A1. The liquid-crystalline mixture is printed here onto an embossing varnish layer that has been provided with an embossment and is embossed and aligned in an embossing process. The liquid crystals are aligned independently of one another at the two interfaces. Together with the dichroitic dye, this gives rise to security features that show different, independent motifs from the two sides that can be rendered visible by irradiation with linear-polarized light. A similar approach is described in document EP 4 129 709 A1. However, embossment from both sides can lead to rolling-out of the uncured material and hence to undefined motifs.

### SUMMARY

Proceeding from this starting point, it is an object of the invention to specify a security element of the type specified at the outset that avoids the disadvantages of the prior art, is easily and inexpensively producible and, as well as an attractive appearance, offers elevated protection against forgeries.

This object is achieved by the features of the independent claims. Developments of the invention are the subject of the dependent claims.

According to the invention, in a security element of the generic type, the latter comprises a first embossing varnish layer disposed on a carrier film, a partial motif layer based on a nematic liquid-crystalline material and a single- or multilayer second embossing varnish layer present over the full area.

The first embossing varnish layer has been provided with an embossment which, for formation of a second latent motif, has at least two regions with alignment structures of different orientation.

The motif layer in the form of a first latent motif is disposed in regions directly atop the first embossing varnish layer and in an overlapping arrangement with the regions that form the second latent motif, where the liquid-crystalline material is aligned homogeneously by virtue of the motif-forming regions in the form of the second latent motif with respectively different orientation such that the motif formed by the different alignment structures is discernible on viewing through a polarizer.

The second embossing varnish layer has been provided with an embossment for creation of a microoptical relief structure and a reflection-increasing coating.

The layer of nematic liquid-crystalline material has polarization-dependent optical effects that cannot be perceived by the eye but are detectable by auxiliary means, for example through polarization filters of the linear or circular type, and in particular can be rendered visible to the viewer's eye by such auxiliary means.

In an advantageous configuration, the liquid-crystalline material is aligned by virtue of a first motif-forming region at an angle to the alignment of the liquid-crystalline material by virtue of a second motif-forming region, and has a different polarizing effect from the first motif-forming region.

The first embossing varnish layer is preferably present over the full area. At least in the region of the motif layer, it advantageously does not have any regions without structures that promote the alignment of the liquid-crystalline material.

In an advantageous configuration, the surface of the first embossing varnish layer facing the liquid crystalline material, in the motif-forming regions, has fine grooves or lattices by which the molecules of the liquid-crystalline material are aligned.

Advantageously, the grooves or lattices have a period length of 0.2 μm to 2.0 μm, preferably of 0.8 μm to 1.2 μm, and a profile depth of 50 nm to 600 nm, preferably of 200 nm to 400 nm.

Advantageously, the refractive index of the first and/or the second embossing varnish layer in the visible spectrum is between the orientation-dependent refractive indices of the motif layer. Likewise advantageously, the refractive indices of the alignment layer and of the second embossing varnish layer in the visible spectrum differ by not more than 0.1, especially by not more than 0.05.

The alignment structures may also be provided solely in the region of the motif layer and in particular in exact register therewith.

In an advantageous configuration, the first latent motif contains one or more first image elements, and the second latent motif contains a multitude of second image elements, where the first and second image elements comprise alphanumeric characters, patterns or codes. Advantageously, the second image elements are arranged in a pattern.

The microoptical relief structure is advantageously formed by a diffractive structure, especially a one- or two-dimensional periodic diffractive structure, by a matt structure, by a subwavelength structure, especially a subwavelength lattice or a motheye structure, and/or by a nondiffractive microstructure, especially an arrangement of micromirrors or microlenses.

The invention also includes a data carrier having a security element of the type described. The data carrier may especially be a document of value, such as a banknote, especially a paper banknote, a polymer banknote or a film composite banknote, a share certificate, a bond certificate, another certificate, a voucher, a check, a seal, a tax strip, a high-value entrance ticket, but also an ID card, for instance a credit card, a bank card, a cash payment card, an authorization card, a personal ID or a passport personalization page.

The invention finally also provides a method of producing a security element of the type described, which comprises
applying a first embossing varnish layer to a carrier film for formation of an alignment layer for homogeneous orientation of a liquid-crystalline material,
providing the first embossing varnish layer with an embossment in order to form a second latent motif by creation of at least two regions with alignment structures of different orientation, and curing the embossing varnish,
applying a motif layer based on a nematic liquid-crystalline material in the form of a first latent motif in regions directly to the first embossing varnish layer and in an overlapping arrangement with the regions that form the second latent motif, where the liquid-crystalline material is aligned with different homogeneous orientation by virtue of the alignment structures of the motif-forming regions,
curing the liquid-crystalline material by exposure to radiation, and
applying a single- or multilayer second embossing varnish layer to the carrier film having the motif layer over the full area, providing the second embossing varnish layer with an embossment to create a microoptical relief structure, and then providing it with a reflection-increasing coating.

In an advantageous configuration of the method, the first embossing varnish layer is embossed without preliminary curing. Preferably, the application of the first embossing varnish layer is preceded by application of a further varnish layer to the carrier film and at least partial curing thereof.

Advantageously, the liquid-crystalline material is physically dried before being exposed to radiation. The liquid-crystalline material is preferably cured by exposure to UV radiation.

Like the second embossing varnish layer, the first embossing varnish layer is also preferably applied over the full area.

It is additionally particularly appropriate for the second embossing varnish layer to be metallized and, if appropriate, demetallized in regions.

Particularly advantageously, the first and/or the second embossing varnish layer and/or the motif layer is/are applied by printing.

In further advantageous configurations, one or more further layers, especially a primer layer, a heat-sealing varnish layer, a print receiver layer and/or a protective layer, are applied to the second embossing varnish layer, especially by printing.

### BRIEF DESCRIPTION OF THE DRAWINGS

The invention is elucidated in detail hereinafter by working examples with reference to the appended figures, which likewise disclose features essential to the invention, and where reproduction to scale and in proportion has been dispensed with in the representation. These working examples serve merely for illustration and should not be interpreted in a restricted manner. The illustrations in the figures, for better understanding, are highly schematized and do not reflect the true circumstances. For avoidance of repetition, identical or mutually corresponding elements in different figures are identified by the same reference numerals and are not elucidated repeatedly.

FIG. 1 shows a schematic diagram of a banknote with an embedded safety filament and a transfer element applied by adhesive bonding.

FIG. 2 shows a cross-sectional view of the construction of a security element in one working example of the invention.

FIG. 3a shows a top view of a working example of a security element with a structured alignment layer and a liquid crystal layer applied in motif form.

FIG. 3b shows an enlarged view of the alignment structure.

FIG. 4a shows a top view of the security element from FIG. 3, as it appears when viewed without auxiliary means.

FIG. 4b shows a top view of the security element from FIG. 3, as it appears when viewed with a circular polarizer.

FIG. 4c shows a top view of the security element from FIG. 3, as it appears when viewed with a linear polarizer in a first position.

FIG. 4d shows a top view of the security element from FIG. 3, as it appears when viewed with a linear polarizer in a second position rotated relative to the latter.

### DETAILED DESCRIPTION OF THE INVENTION

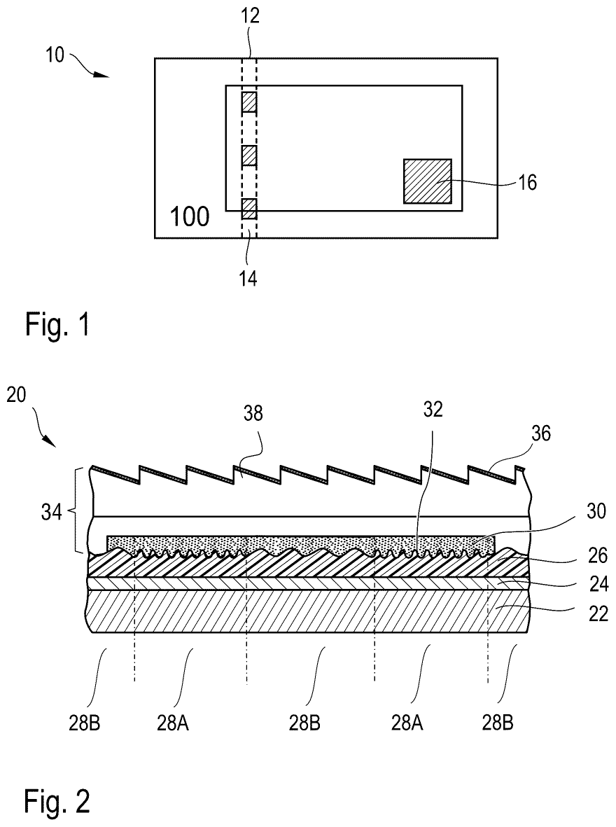

The invention will now be elucidated using the example of security elements for banknotes. In this regard, FIG. 1 shows a schematic diagram of a banknote 10 provided with two security elements 12 and 16 according to working examples of the invention. The first security element is a security filament 12 that appears at the surface of the banknote 10 in particular window regions 14, while it is embedded within the banknote 10 in the intervening regions. The second security element is formed by a transfer element 16 of any shape that has been applied by adhesive bonding. Transfer elements may especially take the form of patches or strips, each with or without their own carrier layer. The security element 16 may also take the form of a cover film disposed above a window region or a continuous opening in the banknote.

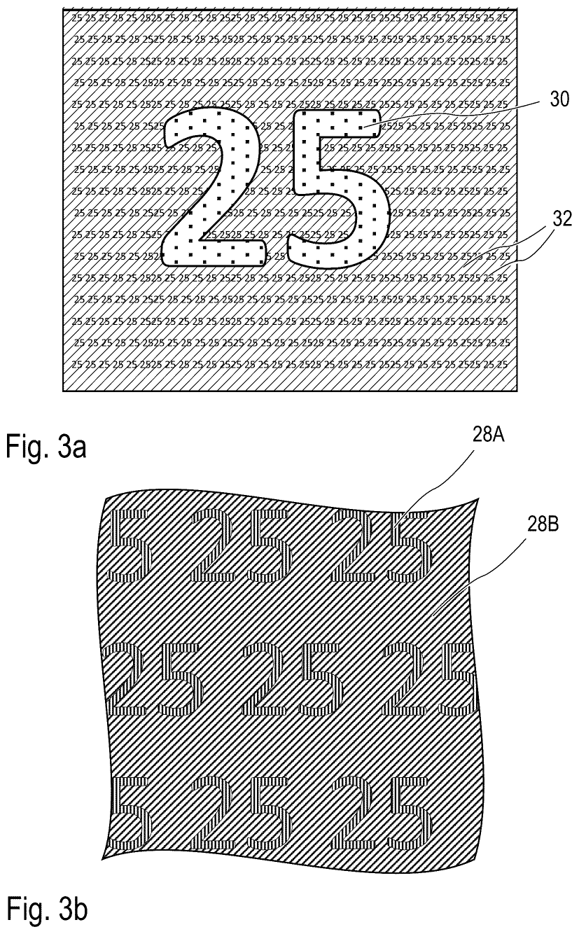

The construction and the production of a security element 20 in a first working example is now elucidated in detail by the cross section in FIG. 2.

The basis used for the security element 20 is a high-quality stretched PET carrier film 22, to which, in the working example, a thin layer 24 of a UV-curable varnish has been applied over the full area. A UV-curable embossing varnish 26 is applied to the (partly or fully cured) varnish layer 24 over the full area, and this is embossed in what is called the casting operation with a minimum degree of prior curing.

The subregions 28A, 28B are each provided with an alignment structure 32 over the full area. The alignment structure 32 consists, for example, of a multitude of parallel grooves that are arranged alongside one another and enable orientation of liquid-crystal molecules. For example, these grooves have a period length of 0.2 μm to 2.0 μm and a profile depth of 200 nm to 600 nm. Lower profile depths are also conceivable, for example in the region of 50 nm. The longitudinal direction of these grooves here constitutes the direction of orientation of the alignment structure.

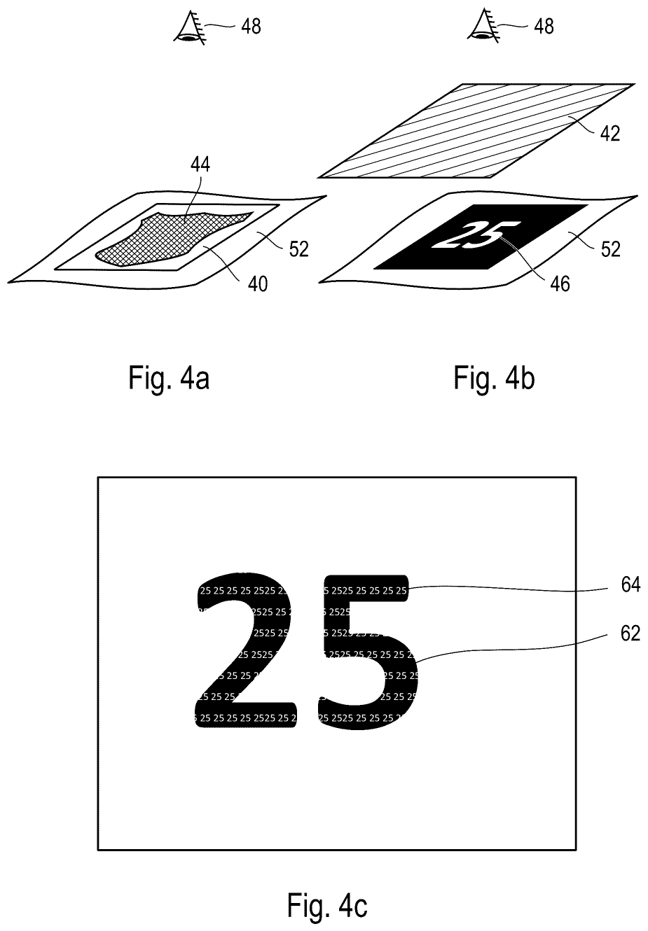

As can be inferred from the illustration in FIGS. 2 and 3, the direction of orientation of the alignment structure 32 is different in subregions 28A and 28B. For example, subregion 28A has a multitude of parallel grooves in a vertical arrangement, subregion 28B a multitude of parallel grooves rotated by 45° relative to the horizontal (indicated by the hatching in FIG. 3b). In the working example, subregion 28A is disposed in the form of a grid in the form of a multitude of repeating image elements (“25”) in front of the background formed by subregion 28B with different aligning orientation (“wallpaper motif”).

A thin layer 30 of a nematic liquid-crystalline material is applied, especially by printing, in the form of a motif (“25”) to the alignment structure 32. For elevated edge sharpness, it may be advantageous to apply the edges or margins of the motif with reduced gram weight.

The motif applied with the aid of the liquid-crystalline material may advantageously have high line thickness. In particular, the dimensions of the motif created by the liquid-crystalline material 30 may be chosen such that they are clearly larger, preferably by a multiple, than the dimensions of the image elements formed by the subregion 28A of the alignment structure 32.

After the liquid-crystal layer 30 has been applied, the nematic liquid crystals are oriented homogeneously in the subregions 28A, 28B in accordance with the alignment structure 32. The liquid-crystal motif layer 30 thus has regions corresponding to subregions 28A, 28B in which the orientation of the liquid crystals is different. The alignments thus obtained, optionally after physical drying to remove any solvents, are fixed by crosslinking the liquid-crystal layer 30 with UV radiation.

A single- or multilayer embossing varnish structure 34 is applied to the resultant layer sequence. In this structure, a relief structure 38, for example a hologram structure or a micromirror structure or a subwavelength lattice, is embossed, and this is then provided with a reflection-increasing coating, for example a metallization 36. It is possible to introduce cutouts (not shown) by partial demetallization, for example in the form of a negative inscription, into the metal layer 36 (for example of aluminum) that has preferably been applied by vapor deposition.

The cutouts may be created with the aid of an etching method or a washing method. When a washing method is used, prior to the application of the metal layer, soluble washable dyes are applied by printing, and these are washed off after vapor deposition together with the PVD layer substances deposited thereon. When an etching method is used, the PVD coating process is conducted first, then a resist is printed and structured. At the unprotected sites, the PVD layer is then removed by an etchant. The remaining resist can remain on the PVD layer or be removed by the use of suitable solvents.

As an alternative to metal layers, the relief structure 38 can also be provided with a layer of high refractive index. Examples of suitable materials of high refractive index are CaS, CrO₂, ZnS, TiO₂ or SiOₓ. It is likewise also possible to apply thin-film elements with a color tilt effect to the relief structure 38 by means of a PVD coating method, and optionally to provide them with cutouts. Such thin-film elements are based in particular on viewing angle-dependent interference effects via multiple reflections in the different sublayers of the element.

The product obtained can be finished in a heat-sealable manner directly with a primer layer and heat-sealing varnish and be applied, for example, to a substrate, e.g. paper. The carrier film 22 may be removed after application to the substrate or remain in the structure as cover film. The latter configurations are used especially in the case of application of security elements that are intended to cover through-holes in the article to be safeguarded.

Prior to the application of the heat-sealing varnish, it is additionally possible to apply further machine-readable and/or decorative layers to the optionally partly demetallized embossing varnish layer 34, especially also in an overlap with the metallization 36. The heat-sealing varnish may additionally contain machine-readable feature substances, for example magnetic, electrically conductive, phosphorescent or fluorescent substances.

The layer structure may alternatively also be processed further, for example, to give what is called a patch or individual security element. For this purpose, a further film, for example a PET film having a low thickness (e.g. 6 μm) may be laminated onto the layer structure. It is then possible to laminate a support film for any subsequent cutting or stamping process onto the side of the carrier film 22, while the surface of the thin PET film mentioned can be provided with primer and heat-sealing varnish. After the preliminary cutting or stamping of the outlines and lattice stripping, the prefabricated individual security elements (patches) can then be applied to a substrate. Methods of producing such a security element transfer material and methods of transferring a security element from the security element transfer material to an article of value are described, for example, in document WO 2010/031543 A1.

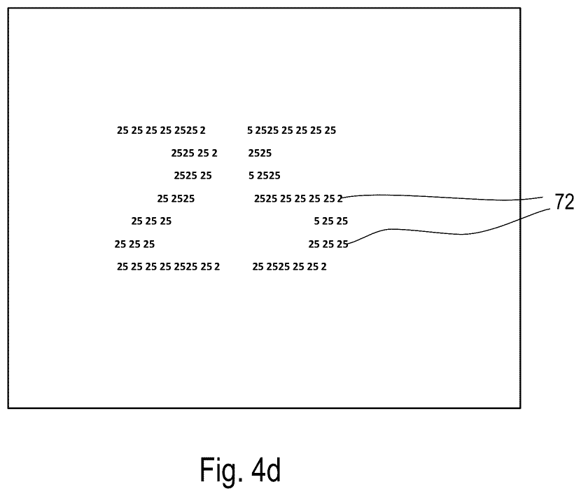

FIG. 4 shows a top view of an individual security element 40 as it appears when viewed without auxiliary means. Viewed without auxiliary means, the security element 40 appears as a metallically shiny, optically variable microstructure, in the working example a relief image 44 in the form of a crest that has been created with the aid of micromirrors (FIG. 4a).

When such a security element 40 is viewed with a circular polarization filter 42, the image motif 46 created by the liquid-crystal layer 30 can be rendered visible and has a light-colored appearance in this region in the form of the characters “25” against a dark background (FIG. 4d). Rotating the polarization filter does not cause any change in the appearance.

A further motif can be rendered visible when the security element is viewed with a linear polarization filter (not shown) (or by a circular polarization filter viewed from the reverse side, i.e. one that has been “inverted”). In this case, the metallically coated regions without the liquid-crystal layer have a light-colored appearance, while the viewer 48, in a first orientation of the linear polarization filter in the region of the liquid-crystal layer, will perceive subregion 28B as a large image element 62 (large “25”) and the region 28A as a light-colored motif in the form of small image elements 64 arranged in a grid (small “25”) (FIG. 4c).

On rotation of the linear polarization filter, there will be a change in the relative brightnesses, which will in fact be reversed in the case of rotation by 45° in the region of the liquid-crystal layer 30, such that the small image elements 72 now become visible as a dark motif, the outline of which is defined by the region of liquid-crystal layer. The background corresponding to subregion 28B appears with merely slight contrast, if any, to the region of the security element 40 that likewise has a light-colored appearance and has not been provided with the liquid-crystal layer 30 (FIG. 4d). The small characters are used here for definition of the larger character.

A particular advantage of the configuration described is that these contain different latent motifs that can be rendered visible depending on the choice of polarization filter used as auxiliary means. In particular, as well as a “macroscopic”, readily discernible motif, it is also possible to create very sharply delimited “microscopic” motifs, since the resolution of the polarizing motif is no longer determined exclusively by print accuracy, but also by the accuracy of the structuring.

Furthermore, the invention offers a more visually interesting image than known latent security features based on liquid crystals. If a security element is of interest to the viewer, there is an increased likelihood that they will pay more attention to the security element and the article of value provided therewith, which in turn achieves a greater security effect.

Since the different motifs, depending on the side of the (circular) polarizing filter through which the security element is being viewed, could be confusing, it is possible to reproduce the motif to be expected in stylized form on the polarization filter used as verification medium on the respective top side. In the case of the side of a circular polarization filter that corresponds to the effect of a linear polarization filter (“inverted” circular polarization), or in the case of a linear polarization filter, it is also possible to reproduce both motifs achievable by rotation in stylized form.

For verification, it is fundamentally necessary here to polarize incident light and outgoing light, which can be achieved by application of a polarization filter. But further variations are also conceivable. For example, the light source that illuminates the viewing region can emit polarized light. Under these circumstances, the viewer is able to use the polarization filter at any point between themself and the article for verification, for example in the form of polarizing spectacles.

The (optically important) steps in the production of the security element begin with the first embossment. The motif of nematic liquid-crystalline material 32 is applied, especially by printing, to the alignment structure 32 created thereby. The alignment structure 32 is filled by the nematic liquid crystals in this region (profile depth of the alignment structure, for example, 200 nm; layer thickness of the nematic liquid-crystal layer, for example, 1 μm). Given suitable choice of the refractive index of the UV embossing varnish 26, the embossed structure will disappear for optical purposes.

In the ideal case, the refractive indices of the adjoining materials are matched to one another such that there will be no occurrence of significant jumps in refractive index that would render the motif of the alignment structure visible even without auxiliary means and hence permanently. Since liquid-crystal layers have an orientation-dependent refractive index, the UV embossing varnish 26 should preferably be chosen such that its refractive index is between the two orientation-dependent refractive indices of the liquid-crystal layer 30.

If discernability of the nematic liquid-crystal layer on viewing of the security element without auxiliary means is undesirable, the alignment quality of the alignment structure 32 should additionally be comparable in all regions 28A, 28B.

In the operation that follows the coating with liquid-crystalline material, for the actual embossment of a hologram or micromirror motif 44 for example, UV embossing varnish 34 is applied over the full area (in two stages in the working example). This means that the nematic liquid-crystal layer 30 lies embedded between UV varnish layers. As well as the nematic motif, the embossing varnish layer 34 directly adjoins the existing embossment 32 or the embossing varnish 26. When the refractive indices are similar (i.e. differ in the visible spectrum by not more than 0.1 and especially by not more than 0.05), the “alignment” embossment or alignment structure 32 will disappear optically here too.

The liquid-crystal layer 30 and the second embossing varnish structure 34 may have different refractive indices. Ideally, the refractive indices here too are matched to one another such that no significant jumps in refractive index occur.

It is possible to confine the first embossment to the region in which the nematic liquid-crystalline material is to be or could be printed (fluctuations in register). However, this confinement requires an insetter operation in the printing of the liquid-crystalline material, which may be associated with an increased level of rejects.

Irrespective of this, an insetter operation may also be required in order to prevent the weld seams (embossing tool with alignment motif and embossing tool with relief structure motif) from getting into the motif and leading to mutual problems as a result of buildup.

1. A security element for safeguarding of articles of value, having a motif layer based on a liquid-crystalline material designed and destined for formation of a latent motif, wherein
the security element comprises a first embossing varnish layer disposed on a carrier film, a partial motif layer based on a nematic liquid-crystalline material and a single- or multilayer second embossing varnish layer present over the full area;
where the first embossing varnish layer has been provided with an embossment having at least two regions with alignment structures of different orientation for formation of a second latent motif;
where the motif layer in the form of a first latent motif is disposed in regions directly atop the first embossing varnish layer and in an overlapping arrangement with the regions that form the second latent motif, where the liquid-crystalline material is aligned homogeneously by virtue of the motif-forming regions in the form of the second latent motif with respectively different orientation such that the motif formed by the different alignment structures is discernible on viewing through a polarizer;
and where the second embossing varnish layer has been provided with an embossment for creation of a microoptical relief structure and a reflection-increasing coating.

2. The security element as claimed in claim 1, wherein the liquid-crystalline material is aligned by virtue of a first motif-forming region at an angle to the alignment of the liquid-crystalline material by virtue of a second motif-forming region, and has a different polarization effect from the first motif-forming region.

3. The security element as claimed in claim 1, wherein the first embossing varnish layer is present over the full area.

4. The security element as claimed in claim 1, wherein the surface of the first embossing varnish layer facing the liquid-crystalline material has, in the motif-forming regions, fine grooves or lattices by which the molecules of the liquid-crystalline material are aligned.

5. The security element as claimed in claim 4, wherein the grooves or lattices have a period length of 0.2 μm to 2.0 μm.

6. The security element as claimed in claim 1, wherein the refractive index of the first and/or the second embossing varnish layer in the visible spectrum is between the orientation-dependent refractive indices of the motif layer.

7. The security element as claimed in claim 1, wherein the refractive indices of the alignment layer and of the second embossing varnish layer in the visible spectrum differ by not more than 0.1, especially by not more than 0.05.

8. The security element as claimed in claim 1, wherein the first latent motif contains one or more first image elements and the second latent motif contains a multitude of second image elements, where the first and second image elements comprise alphanumeric characters, patterns or codes, where the second image elements are arranged in a pattern.

9. The security element as claimed in claim 1, wherein the microoptical relief structure is formed by a diffractive structure, especially one- or two-dimensional periodic diffractive structure, by a matt structure, by a subwavelength structure, especially a subwavelength lattice or a motheye structure, and/or by a nondiffractive microstructure, especially an arrangement of micromirrors or microlenses.

10. A data carrier comprising a security element as claimed in claim 1, wherein the data carrier is especially a document of value or an ID card.

11. A method of producing a security element for safeguarding of articles of value, having a motif layer composed of liquid-crystalline material designed and intended for creation of a latent motif, wherein the method comprises
applying a first embossing varnish layer to a carrier film for formation of an alignment layer for homogeneous orientation of a liquid-crystalline material;
providing the first embossing varnish layer with an embossment in order to form a second latent motif by creation of at least two regions with alignment structures of different orientation, and curing the embossing varnish;
applying a motif layer based on a nematic liquid-crystalline material in the form of a first latent motif in regions directly to the first embossing varnish layer and in an overlapping arrangement with the regions that form the second latent motif, where the liquid-crystalline material is aligned with different homogeneous orientation by virtue of the alignment structures of the motif-forming regions;
curing the liquid-crystalline material by exposure to radiation; and
applying a single- or multilayer second embossing varnish layer to the carrier film having the motif layer over the full area, providing the second embossing varnish layer with an embossment to create a microoptical relief structure, and then providing it with a reflection-increasing coating.

12. The method as claimed in claim 11, wherein the first embossing varnish layer is embossed without preliminary curing, wherein the application of the first embossing varnish layer is preceded by application of a further varnish layer to the carrier film and at least partial curing thereof.

13. The method as claimed in claim 11, wherein the liquid-crystalline material is physically dried prior to the exposure to radiation.

14. The method as claimed in claim 11, wherein the first embossing varnish layer is applied over the full area.

15. The method as claimed in claim 12, wherein the first and/or the second embossing varnish layer and/or the motif layer is applied by printing.
